(19) United States
(12) Patent Application Publication
(10) Pub. No.: US 2014/0241219 A1
(43) Pub. Date: Aug. 28, 2014

(54) METHOD AND APPARATUS FOR COEXISTENCE OF PEER TO PEER COMMUNICATION WITH LTE WWAN COMMUNICATION ON DOWNLINK

(71) Applicant: QUALCOMM Incorporated, San Diego, CA (US)

(72) Inventors: Shailesh Patil, Bridgewater, NJ (US); Hua Wang, Bridgewater, NJ (US); Libin Jiang, Bridgewater, NJ (US)

(21) Appl. No.: 13/921,673

(22) Filed: Jun. 19, 2013

Related U.S. Application Data
(60) Provisional application No. 61/771,001, filed on Feb. 28, 2013.

(51) Int. Cl. H04W 72/02; H04J 3/16

(52) U.S. Cl. CPC H04W 72/02; H04J 3/1694
USPC 370/280; 370/330

(57) ABSTRACT

A method, an apparatus, and a computer program product for wireless communication are provided. A UE for wireless communication determines resource elements, within at least one resource block in a downlink subframe, that carry reference signals from a base station. The UE maps at least one of data or control information to the at least one resource block, punctures the at least one of the data or the control information from the resource elements determined to carry the reference signals, and transmits the at least one resource block to a second UE.

### CROSS-REFERENCE TO RELATED APPLICATION(S)

This application claims the benefit of U.S. Provisional Application Ser. No. 61/771,001, entitled “Method and Apparatus for Coexistence of Peer to Peer Communication with LTE WWAN Communication on Downlink” and filed on Feb. 28, 2013, which is expressly incorporated by reference herein in its entirety.

### BACKGROUND

1. Field

The present disclosure relates generally to communication systems, and more particularly, to a method and apparatus for coexistence of peer to peer communication with LTE wireless wide area network (WWAN) communication on downlink.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

Aspects of the disclosure provide methods, apparatuses and computer program products for coexistence of peer to peer communication with LTE WWAN communication on downlink. In one aspect, a user equipment (UE) for wireless communication determines resource elements, within at least one resource block in a downlink subframe, that carry reference signals from a base station. The UE maps at least one of data or control information to the at least one resource block, punctures the at least one of the data or the control information from the resource elements determined to carry the reference signals, and transmits the at least one resource block to a second UE.

In another aspect, a UE for wireless communication determines resource elements, within at least one resource block in a downlink subframe, that normally carry reference signals from a base station. The UE then transmits a pilot signal on the determined resource elements.

In another aspect, a UE for wireless communication determines downlink subframes for peer to peer communication within a set of downlink subframes used for both WWAN communication and peer to peer communication. The determined downlink subframes are possibly non-contiguous in the set of downlink subframes. The UE then communicates with a second UE in a subset of the determined downlink subframes.

In another aspect, a base station determines downlink subframes for peer to peer communication within a set of downlink subframes used for both WWAN communication and peer to peer communication, and receives a first channel quality indicator (CQI) from a UE in an uplink subframe following one of the determined downlink subframes, the CQI being based on reference signals in one of the determined downlink subframes. The base station determines that the UE is within a first subset of UEs of a set of UEs including the first subset of UEs and a second subset of UEs, and schedules the UE based on a second CQI different than the first CQI.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram of a device-to-device (D2D) communications system.

FIG. 8 is a diagram illustrating reference signals in a DL frame structure in LTE.

FIG. 9 is a flow chart of a method of wireless communication of a UE.

FIG. 10 is a conceptual data flow diagram illustrating the data flow between different modules/means/components of an UE that implements the method of FIG. 9.

FIG. 11 is a diagram illustrating a hardware implementation for an UE employing a processing system to implement the method of FIG. 9.

FIG. 12 is a flow chart of another method of wireless communication of a UE.

FIG. 13 is a conceptual data flow diagram illustrating the data flow between different modules/means/components of an UE that implements the method of FIG. 12.

FIG. 14 is a diagram illustrating a hardware implementation for an UE employing a processing system to implement the method of FIG. 12.

FIG. 15 is a flow chart of another method of wireless communication of a UE.

FIG. 16 is a conceptual data flow diagram illustrating the data flow between different modules/means/components of an UE that implements the method of FIG. 15.

FIG. 17 is a diagram illustrating a hardware implementation for an UE employing a processing system to implement the method of FIG. 15.

FIG. 18 is a flow chart of a method of wireless communication of an eNB.

FIG. 19 is a conceptual data flow diagram illustrating the data flow between different modules/means/components of an eNB that implements the method of FIG. 18.

FIG. 20 is a diagram illustrating a hardware implementation for an eNB employing a processing system to implement the method of FIG. 18.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

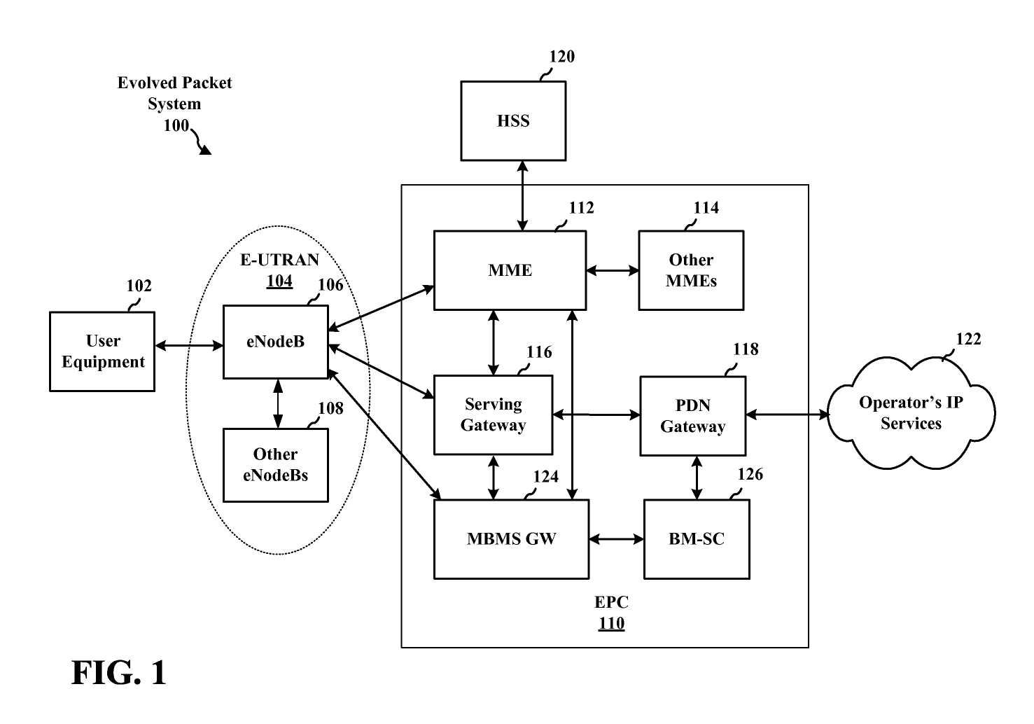

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 includes a Mobility Management Entity (MME) 112, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, an intranet, an IP Multimedia Subsystem (IMS), and a PS Streaming Service (PSS). The BM-SC 126 is the source of MBMS traffic. The MBMS Gateway 124 distributes the MBMS traffic to the eNBs 106, 108.

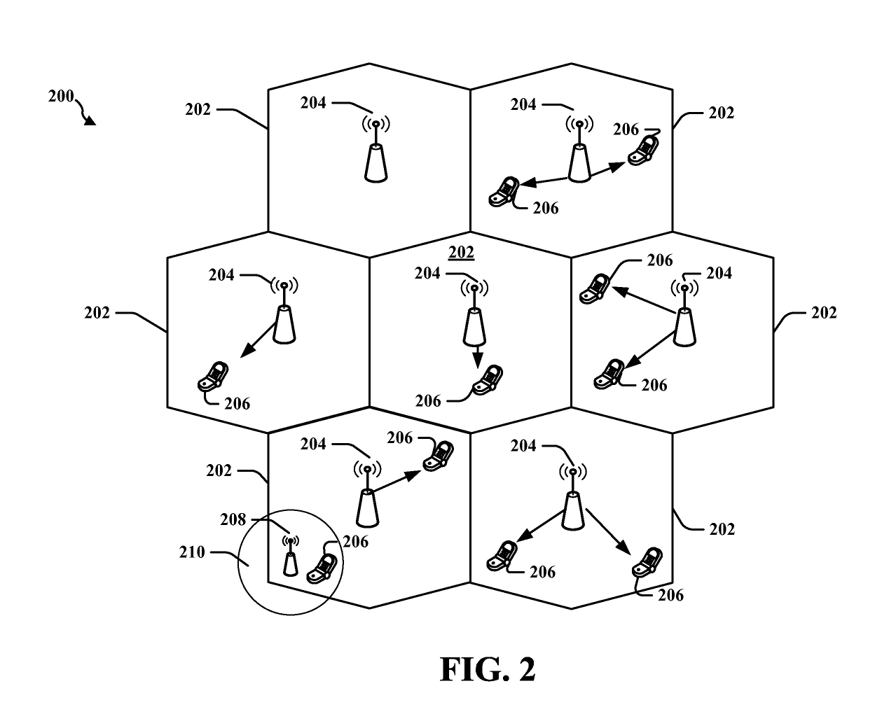

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

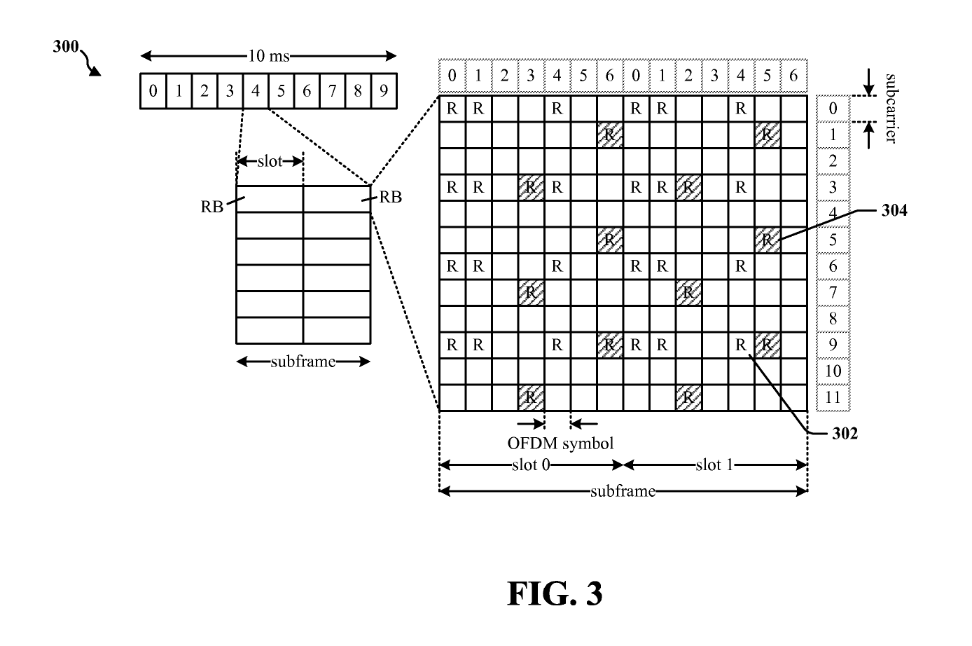

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

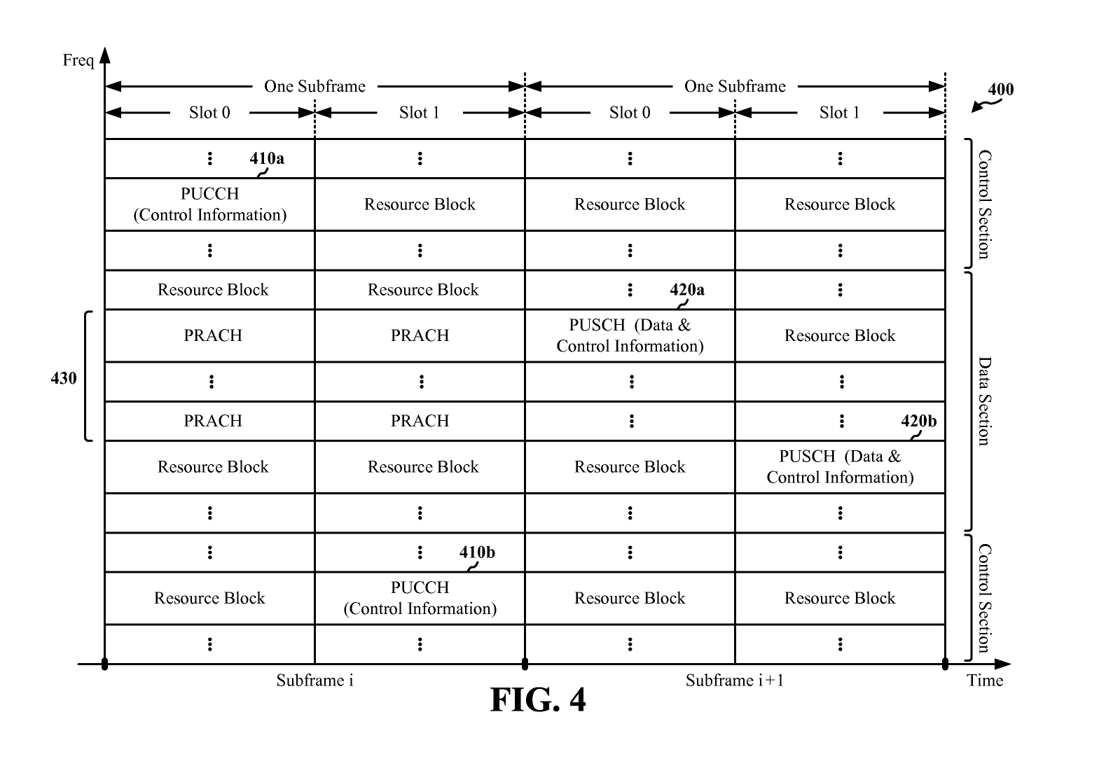

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

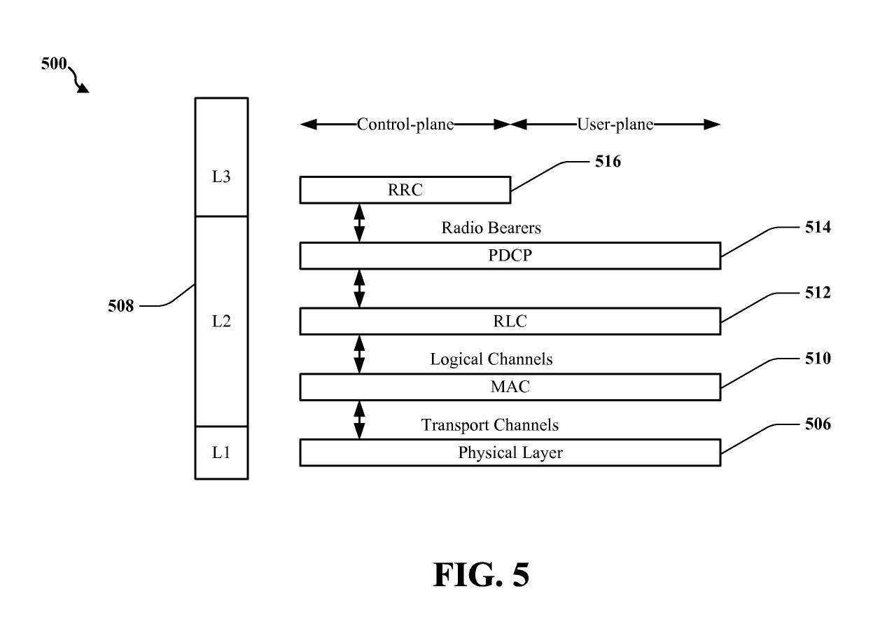

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

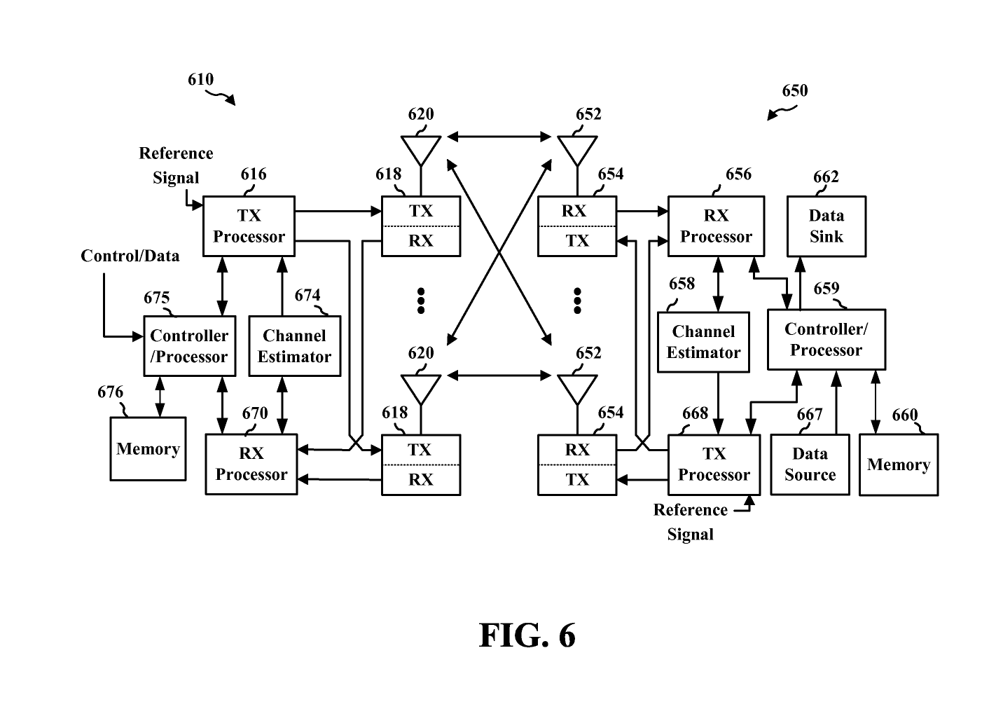

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

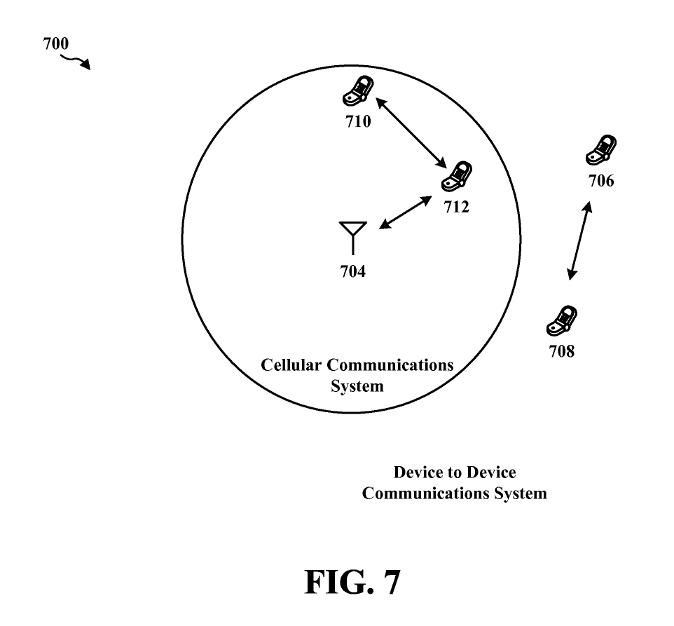

FIG. 7 is a diagram 700 of an exemplary device-to-device (D2D) communications system. The device-to-device communications system 700 includes a plurality of wireless devices 706, 708, 710, 712. The device-to-device communications system 700 may overlap with a cellular communications system, such as for example, a wireless wide area network (WWAN) (e.g., access network 200). Some of the wireless devices 706, 708, 710, 712 may communicate together in device-to-device communication, some may communicate with the base station 704, and some may do both. Device-to-device communication may be effectuated by directly transferring signals between the wireless devices. Thus, the signals need not traverse through an access node (e.g., a base station) or centrally managed network. Device-to-device communication may provide short range, high data rate communication. As shown in FIG. 7, the wireless devices 706, 708 are in device-to-device communication and the wireless devices 710, 712 are in device-to-device communication. The wireless device 712 is also communicating with the base station 704.

The wireless device may alternatively be referred to by those skilled in the art as user equipment (UE), a mobile station, a subscriber station, a mobile unit, a subscriber unit, a wireless unit, a wireless node, a remote unit, a mobile device, a wireless communication device, a remote device, a mobile subscriber station, an access terminal, a mobile terminal, a wireless terminal, a remote terminal, a handset, a user agent, a mobile client, a client, or some other suitable terminology. The base station may alternatively be referred to by those skilled in the art as an access point, a base transceiver station, a radio base station, a radio transceiver, a transceiver function, a basic service set (BSS), an extended service set (ESS), a Node B, an evolved Node B, or some other suitable terminology.

The exemplary methods and apparatuses discussed infra are applicable to any of a variety of wireless device-to-device communications systems, such as for example, a wireless device-to-device communication system based on FlashLinQ, WiMedia, Bluetooth, ZigBee, or Wi-Fi based on the IEEE 802.11 standard. One of ordinary skill in the art would understand that the exemplary methods and apparatuses are applicable more generally to a variety of other wireless device-to-device communication systems.

In a WWAN scenario, communications between UEs typically pass through both the uplink and downlink channels between UEs and eNBs. In cases where two communicating UEs are in the vicinity of each other, it may be desirable to implement D2D communication between the UEs without going through an eNB. Doing so is beneficial in that it may reduce the eNB load and introduce new proximity based services. Typically, such D2D communication occurs only on the uplink in a FDD system. This is due to regulatory and other issues. In TDD, however, D2D communication can also occur on the downlink.

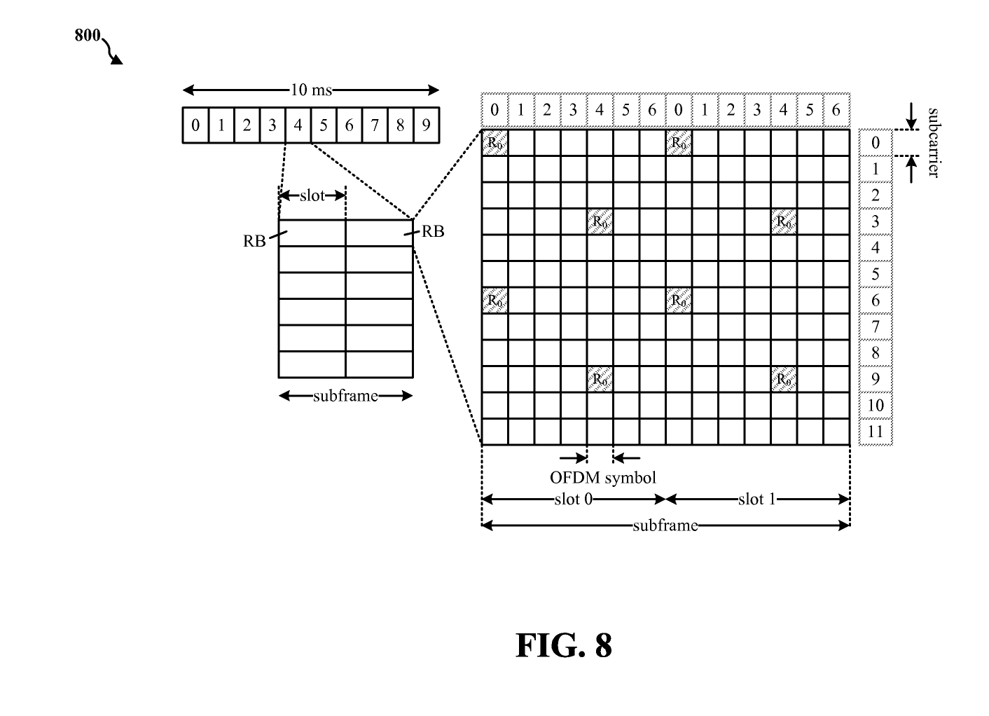

To enable D2D communication on the downlink in a TDD system, a subset of the downlink subframes may be reserved for D2D communication. Preferably, no WWAN communication takes place either in the whole subframe being used for D2D communication or at least on the PDSCH portion of the subframe. The LTE specification, however, stipulates that an eNB shall transmit reference signals on every downlink subframe. This is illustrated in the FIG. 8, where ‘R₀’ indicates the location on which reference signals are transmitted in a resource block (RB). Such reference signals transmitted by an eNB may interfere with D2D communication.

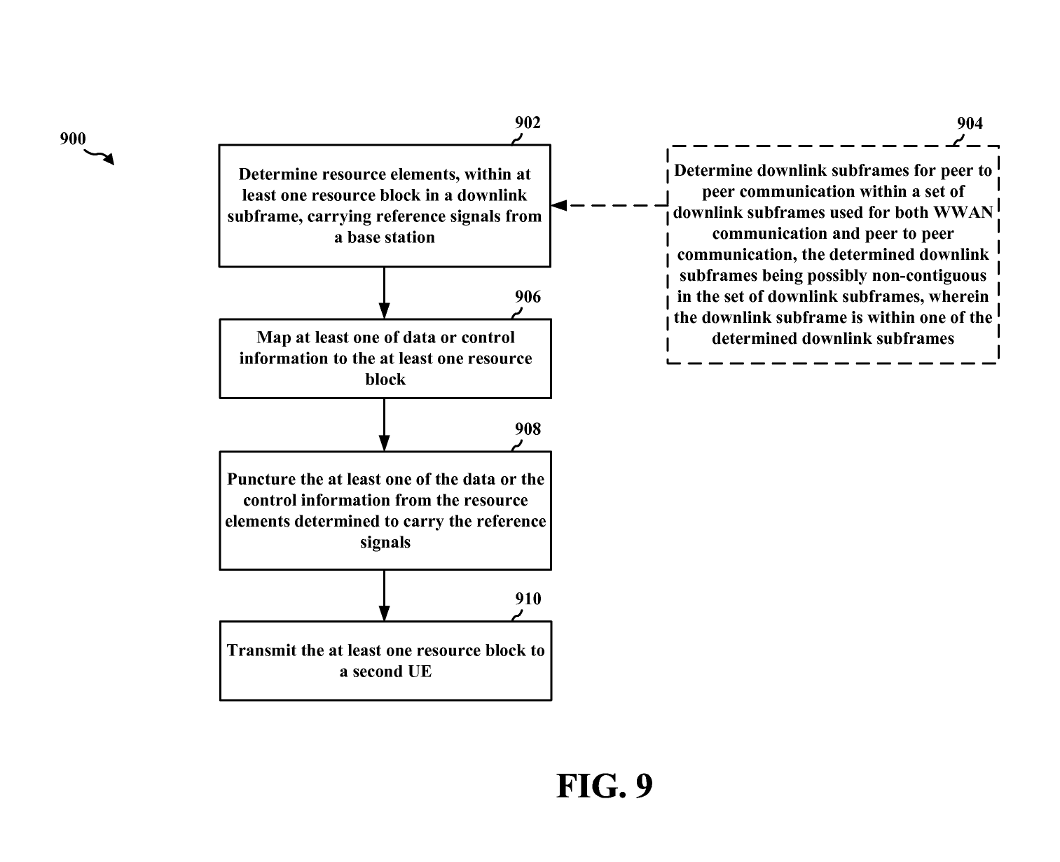

FIG. 9 is a flow chart 900 of a method of wireless communication of a UE. The method addresses the issue of interference caused by reference signals transmitted by eNBs during D2D communication, and is implemented through the physical layer. In this method, a UE engaging in D2D communication determines the resource elements on which an eNB will transmit eNB reference signals. While engaging in D2D communication the UE punctures the resources so that the UE does not transmit on those resource elements on which the eNB will transmit reference signals, as previously determined by the UE. Accordingly, the eNB continues to transmit eNB reference signals on all downlink subframes, as stipulated by the LTE specification.

Continuing with FIG. 9 to further describe the method, at step 902, a UE determines resource elements, within at least one resource block in a downlink subframe, carrying reference signals from a base station. Such determination may be based on, for example, physical cell identity information contained in synchronization signals transmitted by the base station and received by the UE.

Optionally, the UE may select particular downlink subframes for which it will determine resource elements carrying reference signals for a base station. To this end, at step 904, the UE may determine a subset of downlink subframes to use for peer to peer communication within a set of downlink subframes used for WWAN communication and peer to peer communication. The downlink subframes in the determined subset may be non-contiguous in the set of downlink subframes. In one configuration the downlink subframes in the determined subset are non-contiguous. The downlink subframe of step 902 corresponds to one of the downlink subframes in the determined subset.

At step 906, the UE maps at least one of data or control information to the at least one resource block that include resource elements previously determined by the UE to carry reference signals from the base station. Such mapping may initially map information to one or more resource elements determined to carry reference signals from the base station. At step 908, however, the UE punctures the data and/or the control information from the resource elements determined to carry the reference signals from the base station so that no data or control information from the UE is transmitted on those resource elements. The base station continues to transmit reference signals on those resource elements in accordance with current LTE specifications.

Continuing with FIG. 9, at step 910, the UE transmits the at least one resource block to a second UE to effectuate a D2D communication. In the foregoing method, the wireless communication is in a TDD system.

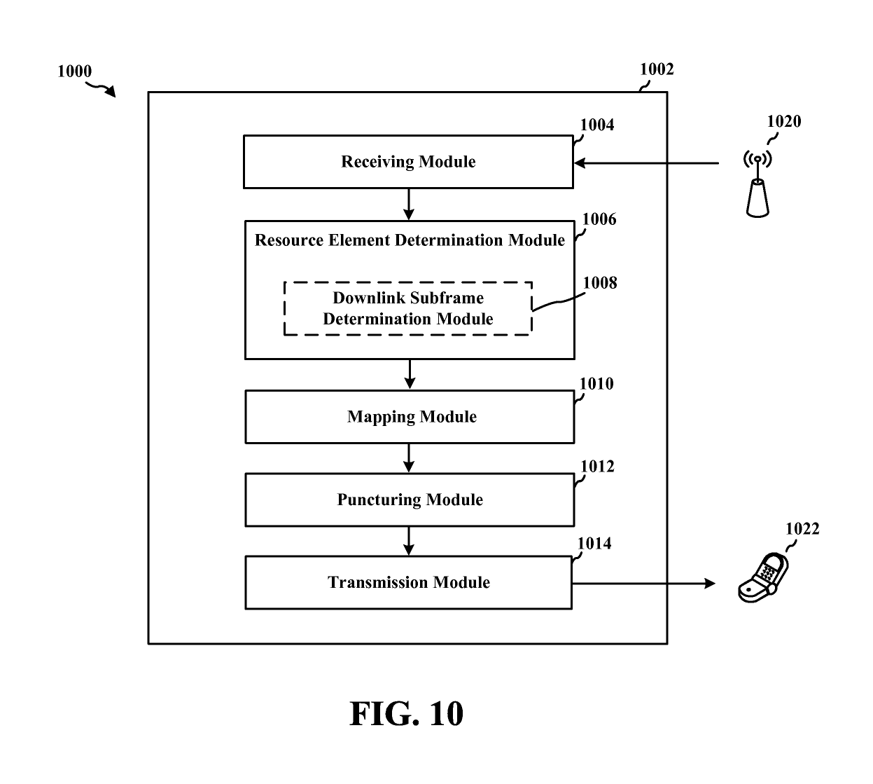

FIG. 10 is a conceptual data flow diagram 1000 illustrating the data flow between different modules/means/components in an exemplary UE 1002. The UE 1002 includes a receiving module 1004 that receives signals from a base station 1020, and a resource element determination module 1006 that determines resource elements that carry reference signals from the base station 1020. The resource elements are within at least one resource block in a downlink subframe. The resource element determination module 1006 may determine these resource elements based on, for example, physical cell identity information contained in synchronization signals transmitted by the base station 1020 and received by the UE.

Optionally, the resource element determination module 1006 includes a downlink subframe determination module 1008 that determines a subset of downlink subframes for peer to peer communication within a set of downlink subframes used for both WWAN communication and peer to peer communication. The downlink subframes in the determined subset may be non-contiguous in the set of downlink subframes, and the downlink subframe determined by the resource element determination module 1006 corresponds to one of the downlink subframes in the determined subset. In one configuration the downlink subframes in the determined subset are non-contiguous.

The UE 1002 also includes a mapping module 1010 that maps at least one of data or control information to the at least one resource block where the determined resource elements are located. The UE 1002 also includes a puncturing module 1010 that punctures the at least one of the data or the control information from the resource elements determined to carry the reference signals. The UE further includes a transmission module 1012 that transmits the at least one resource block to a second UE 1022.

The UE 1002 may include additional modules that perform each of the steps of the algorithm in the aforementioned flow chart of FIG. 9. As such, each step in the aforementioned flow chart of FIG. 9 may be performed by a module and the UE may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

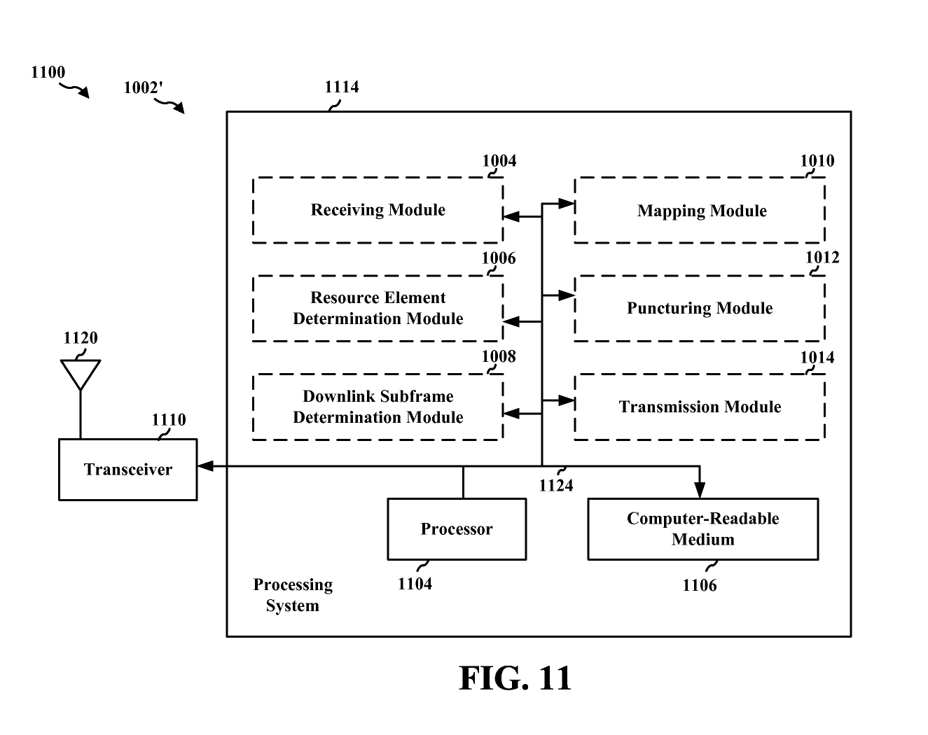

FIG. 11 is a diagram 1100 illustrating an example of a hardware implementation for an UE 1002′ employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware modules, represented by the processor 1104, the modules 1004, 1006, 1008, 1010, 1012, 1014 and the computer-readable medium 1106. The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The transceiver 1110 receives a signal from the one or more antennas 1120, extracts information from the received signal, and provides the extracted information to the processing system 1114, specifically the receiving module 1004. In addition, the transceiver 1110 receives information from the processing system 1114, specifically the transmission module 1014, and based on the received information, generates a signal to be applied to the one or more antennas 1120.

The processing system 1114 includes a processor 1104 coupled to a computer-readable medium 1106. The processor 1104 is responsible for general processing, including the execution of software stored on the computer-readable medium 1106. The software, when executed by the processor 1104, causes the processing system 1114 to perform the various functions described supra for any particular apparatus. The computer-readable medium 1106 may also be used for storing data that is manipulated by the processor 1104 when executing software. The processing system further includes at least one of the modules 1004, 1006, 1008, 1010, 1012 and 1014. The modules may be software modules running in the processor 1104, resident/stored in the computer readable medium 1106, one or more hardware modules coupled to the processor 1104, or some combination thereof. The processing system 1114 may be a component of the UE 650 and may include the memory 660 and/or at least one of the TX processor 668, the RX processor 656, and the controller/processor 659.

In one configuration, the UE 1002/1002′ for wireless communication includes means for determining resource elements, within at least one resource block in a downlink subframe, carrying reference signals from a base station; means for mapping at least one of data or control information to the at least one resource block; means for puncturing the at least one of the data or the control information from the resource elements determined to carry the reference signals; and means for transmitting the at least one resource block to a second UE. The UE 1002/1002′ may further include means for determining downlink subframes for peer to peer communication within a set of downlink subframes used for WWAN communication and peer to peer communication. The determined downlink subframes are possibly non-contiguous in the set of downlink subframes, and the downlink subframe to which data and/or control information is mapped by the UE corresponds to, or is within, one of the determined downlink subframes. In one configuration the determined downlink subframes are non-contiguous.

The aforementioned means may be one or more of the aforementioned modules of the UE 1002 and/or the processing system 1114 of the UE 1002′ configured to perform the functions recited by the aforementioned means. As described supra, the processing system 1114 may include the TX processor 668, the RX processor 656, and the controller/processor 659. As such, in one configuration, the aforementioned means may be the TX processor 668, the RX processor 656, and the controller/processor 659 configured to perform the functions recited by the aforementioned means.

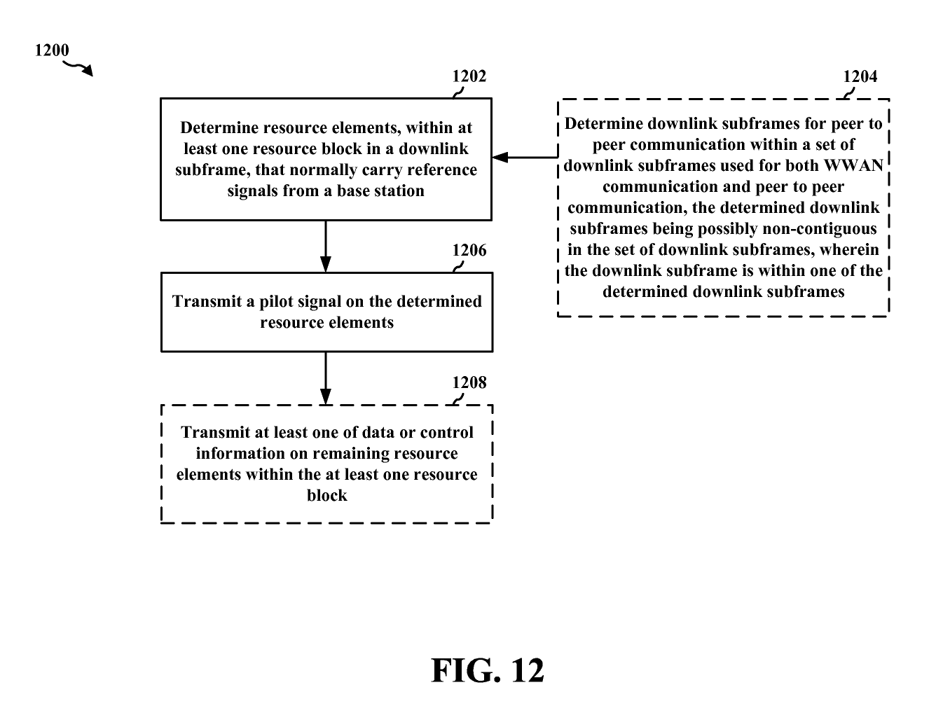

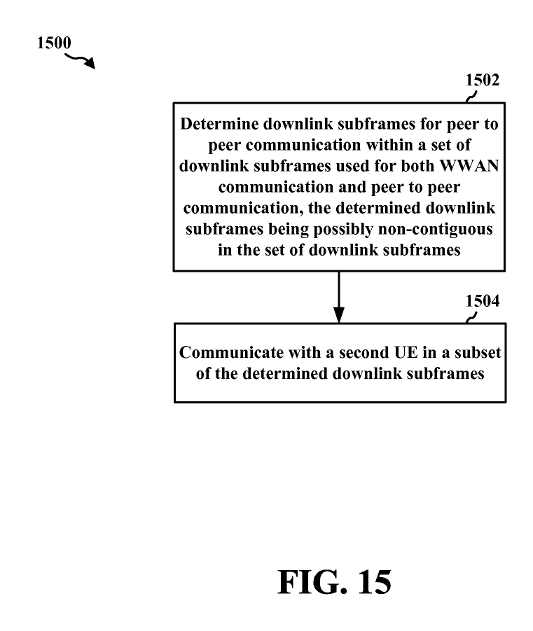

The methods and apparatuses described with reference to FIGS. 9, 10 and 11 provide coexistent peer to peer communication and WWAN communication on the downlink in compliance with LTE specifications. However due to timing difference and frequency offset between WWAN and D2D communication there may be leakage from WWAN reference signals to D2D signals and vice versa. The leakage to D2D communication can be significant when D2D communication is occurring near an eNB. In the other direction, the leakage to legacy UEs can be significant if they are close to a UE engaging in D2D communication. Additional methods that address these issues are described below in FIGS. 12 and 15.

FIG. 12 is a flow chart of a method of wireless communication of a UE. This method addresses the potential leakage issues of the method of FIG. 9 by providing for transmission of UE pilot signals on resource elements that normally carry reference signals from a base station. The eNB reference signals are not transmitted in downlink subframes reserved for D2D communication, thus essentially eliminating the potential for leakage.

This method, however, may potentially confuse legacy UEs, i.e., UEs that are not LTE-Direct (LTE-D) aware, that are expecting reference signals on every subframe in accordance with current LTE specifications. If the expected reference signals from the eNB are not present, legacy UEs that are in the vicinity of UEs engaging in D2D communication may make errors in channel estimation and reporting channel quality indicator (CQI) values to the eNB. Specifically, these legacy UEs may significantly over estimate the CQI value and report the high value to the eNB. A high incorrect CQI value (due to opportunistic scheduling) can bias the eNB to schedule the legacy UE, thus negatively affecting the WWAN downlink throughput. Aspects of the method of FIG. 12 address these issues.

Continuing with FIG. 12 to further describe this method, at step 1202, the UE determines resource elements, within at least one resource block in a downlink subframe, that normally carry reference signals from a base station. Such determination may be based on, for example, physical cell identity information contained in synchronization signals transmitted by the base station and received by the UE.

Optionally, the UE may select particular downlink subframes for which it will determine resource elements carrying reference signals for a base station. To this end, at step 1204, the UE may determine a subset of downlink subframes to use for peer to peer communication within a set of downlink subframes used for WWAN communication and peer to peer communication. The downlink subframes in the determined subset may be non-contiguous in the set of downlink subframes. In one configuration the downlink subframes in the determined subset are non-contiguous. The downlink subframe of step 1202 corresponds to one of the downlink subframes in the determined subset.

At step 1206, the UE transmits a pilot signal on the determined resource elements. In one configuration the pilot signal is a sequence y₁, y₂, . . , yₖ determined such that:

Σⱼ₌₁^{k}conjugate(xⱼ)yⱼ is zero or low,

where x₁, x₂, . . . xₖ is a sequence corresponding to a pilot signal normally transmitted by the base station on the resource elements.

The pilot signal transmitted by the UE provides for zero or low correlation between the UE pilot signal and the pilot signal expected by legacy UEs. Transmission of such sequences is advantageous because legacy UEs will correlate the received reference signal sequence y₁, . . . yₖ with the expected sequence x₁, . . . , xₖ and the received energy will be calculated to be low. This prevents the UE from reporting incorrect high CQI values and thus reduces any potential loss in downlink throughput. Meanwhile, there is no leakage from WWAN communication to peer to peer communication since the eNB reference signals are not transmitted in downlink subframes reserved for D2D communication.

Continuing with FIG. 12, at step 1208, the UE optionally transmits at least one of data or control information on remaining resource elements within the at least one resource block. In the foregoing method, the wireless communication is in a TDD system.

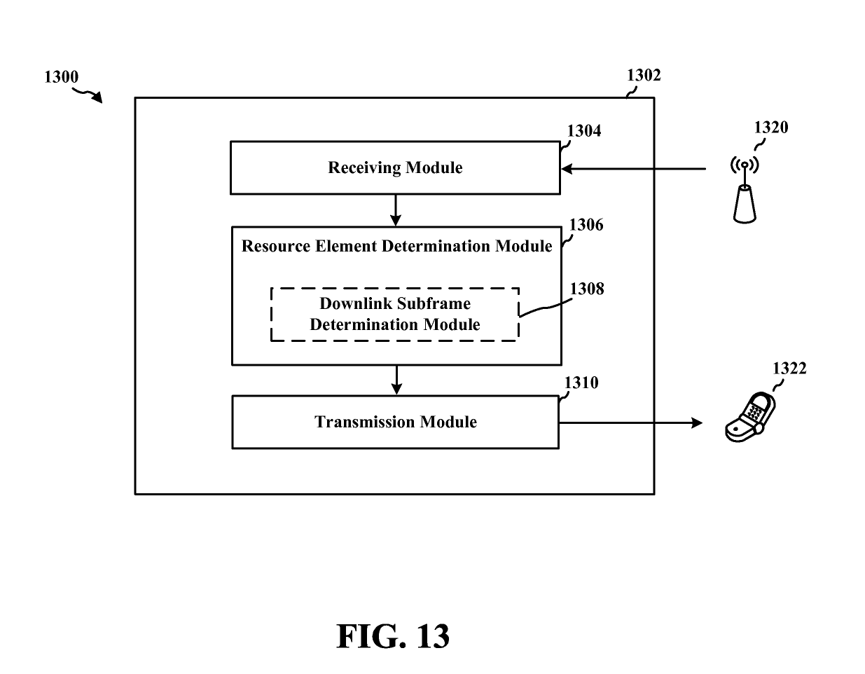

FIG. 13 is a conceptual data flow diagram 1300 illustrating the data flow between different modules/means/components in an exemplary UE 1302. The UE 1302 includes a receiving module 1304 that receives signals from a base station 1320, and a resource element determination module 1306 that determines resource elements that carry reference signals from the base station 1320. The resource elements are within at least one resource block in a downlink subframe. The resource element determination module 1306 may determine these resource elements based on, for example, physical cell identity information contained in synchronization signals transmitted by the base station 1320 and received by the UE.

Optionally, the resource element determination module 1306 includes a downlink subframe determination module 1308 that determines a subset of downlink subframes for peer to peer communication within a set of downlink subframes used for both WWAN communication and peer to peer communication. The downlink subframes in the determined subset may be non-contiguous in the set of downlink subframes, and the downlink subframe determined by the resource element determination module 1306 corresponds to one of the downlink subframes in the determined subset. In one configuration the downlink subframes in the determined subset are non-contiguous.

The UE 1302 also includes a transmission module 1310 that transmits a pilot signal on the determined resource elements to a second UE 1322. The transmission module 1310 may also transmit at least one of data or control information on remaining resource elements within the at least one resource block.

The UE 1302 may include additional modules that perform each of the steps of the algorithm in the aforementioned flow chart of FIG. 12. As such, each step in the aforementioned flow chart of FIG. 12 may be performed by a module and the UE may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

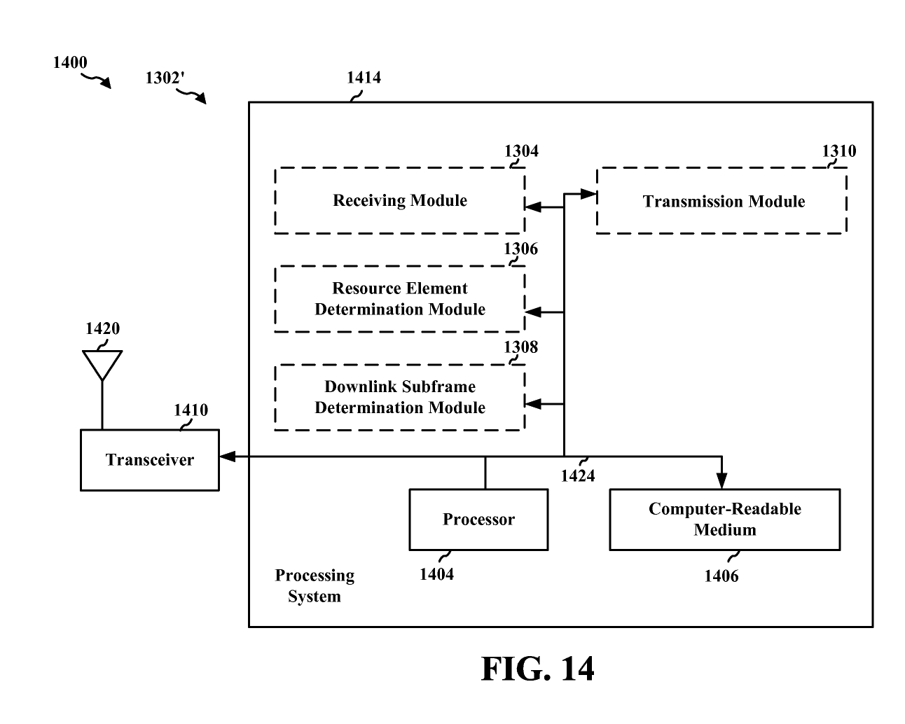

FIG. 14 is a diagram 1400 illustrating an example of a hardware implementation for an UE 1302′ employing a processing system 1414. The processing system 1414 may be implemented with a bus architecture, represented generally by the bus 1424. The bus 1424 may include any number of interconnecting buses and bridges depending on the specific application of the processing system 1414 and the overall design constraints. The bus 1424 links together various circuits including one or more processors and/or hardware modules, represented by the processor 1404, the modules 1304, 1306, 1308, 1310 and the computer-readable medium 1406. The bus 1424 may also link various other circuits such as timing sources, peripherals, voltage regulators, and power management circuits, which are well known in the art, and therefore, will not be described any further.

The processing system 1414 may be coupled to a transceiver 1410. The transceiver 1410 is coupled to one or more antennas 1420. The transceiver 1410 provides a means for communicating with various other apparatus over a transmission medium. The transceiver 1410 receives a signal from the one or more antennas 1420, extracts information from the received signal, and provides the extracted information to the processing system 1414, specifically the receiving module 1304. In addition, the transceiver 1410 receives information from the processing system 1414, specifically the transmission module 1310, and based on the received information, generates a signal to be applied to the one or more antennas 1420.

The processing system 1414 includes a processor 1404 coupled to a computer-readable medium 1406. The processor 1404 is responsible for general processing, including the execution of software stored on the computer-readable medium 1406. The software, when executed by the processor 1404, causes the processing system 1414 to perform the various functions described supra for any particular apparatus. The computer-readable medium 1406 may also be used for storing data that is manipulated by the processor 1404 when executing software. The processing system further includes at least one of the modules 1304, 1306, 1308 and 1310. The modules may be software modules running in the processor 1404, resident/stored in the computer readable medium 1406, one or more hardware modules coupled to the processor 1404, or some combination thereof. The processing system 1414 may be a component of the UE 650 and may include the memory 660 and/or at least one of the TX processor 668, the RX processor 656, and the controller/processor 659.

In one configuration, the UE 1302/1302′ for wireless communication includes means for determining resource elements, within at least one resource block in a downlink subframe, carrying reference signals from a base station; and means for transmitting a pilot signal on the determined resource elements. The UE 1302/1302′ may also include means for transmitting at least one of data or control information on remaining resource elements within the at least one resource block, and means for determining downlink subframes for peer to peer communication within a set of downlink subframes used for WWAN communication and peer to peer communication. The determined downlink subframes are possibly non-contiguous in the set of downlink subframes, wherein the downlink subframe on which the pilot signal is transmitted by the UE corresponds to, or is within, one of the determined downlink subframes. In one configuration the determined downlink subframes are non-contiguous.

The aforementioned means may be one or more of the aforementioned modules of the UE 1302 and/or the processing system 1414 of the UE 1302′ configured to perform the functions recited by the aforementioned means. As described supra, the processing system 1414 may include the TX processor 668, the RX processor 656, and the controller/processor 659. As such, in one configuration, the aforementioned means may be the TX processor 668, the RX processor 656, and the controller/processor 659 configured to perform the functions recited by the aforementioned means.

The methods of FIGS. 9 and 12 optionally provided non-contiguous downlink subframes for peer to peer communications. Accordingly, peer to peer subframes are interspersed with WWAN subframes resulting in a more accurate estimation of CQI by legacy UEs. Further to this, an additional method of D2D communication on downlink is described.

FIG. 15 is a flow chart 1500 of a method of wireless communication of a UE. At step 1502, the UE determines downlink subframes for peer to peer communication within a set of downlink subframes used for both WWAN communication and peer to peer communication. The determined downlink subframes are possibly non-contiguous in the set of downlink subframes. In one configuration the determined downlink subframes are non-contiguous. At step 1504, the UE communicates with a second UE in a subset of the determined downlink subframes. In the foregoing method, the wireless communication is in a TDD system.

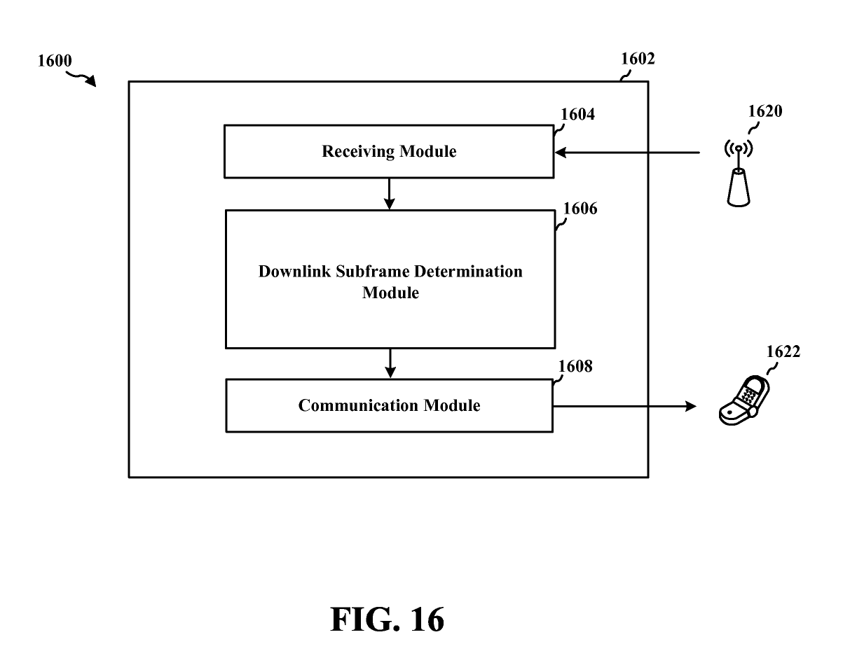

FIG. 16 is a conceptual data flow diagram 1600 illustrating the data flow between different modules/means/components in an exemplary UE 1602. The UE 1602 includes a receiving module 1604 that receives signals from a base station 1620, and a downlink subframe determination module 1606 that determines a subset of downlink subframes for peer to peer communication within a set of downlink subframes used for both WWAN communication and peer to peer communication. The downlink subframes in the determined subset are possibly non-contiguous in the set of downlink subframes. In one configuration the downlink subframes in the determined subset are non-contiguous. The UE 1602 also includes a communication module 1608 that communicates with a second UE in a subset of the determined downlink subframes.

The UE 1602 may include additional modules that perform each of the steps of the algorithm in the aforementioned flow chart of FIG. 15. As such, each step in the aforementioned flow chart of FIG. 15 may be performed by a module and the UE may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

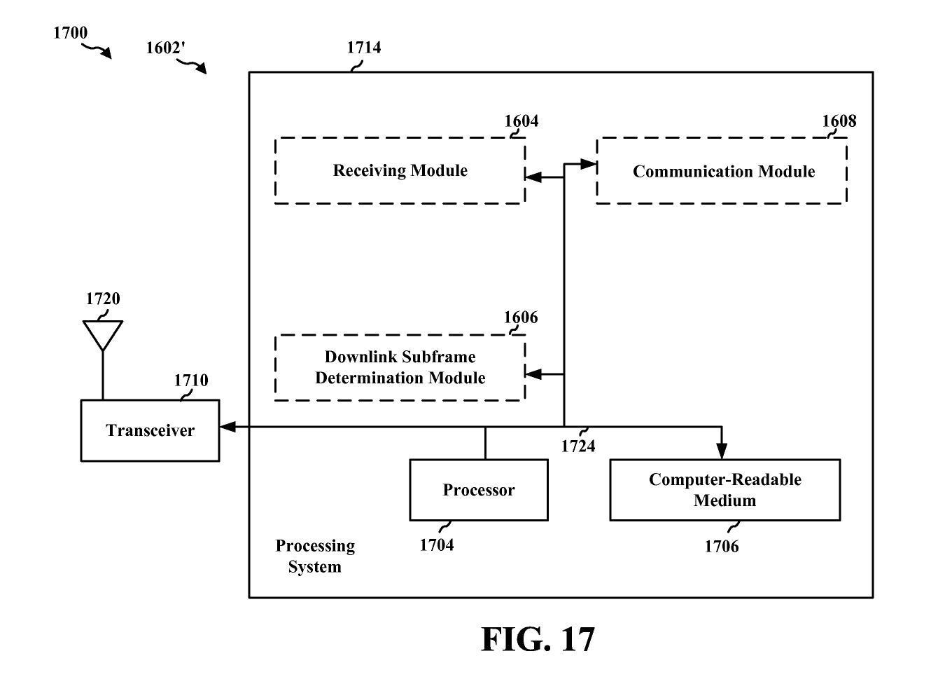

FIG. 17 is a diagram 1700 illustrating an example of a hardware implementation for an UE 1602′ employing a processing system 1714. The processing system 1714 may be implemented with a bus architecture, represented generally by the bus 1724. The bus 1724 may include any number of interconnecting buses and bridges depending on the specific application of the processing system 1714 and the overall design constraints. The bus 1724 links together various circuits including one or more processors and/or hardware modules, represented by the processor 1704, the modules 1604, 1606, 1608 and the computer-readable medium 1706. The bus 1724 may also link various other circuits such as timing sources, peripherals, voltage regulators, and power management circuits, which are well known in the art, and therefore, will not be described any further.

The processing system 1714 may be coupled to a transceiver 1710. The transceiver 1710 is coupled to one or more antennas 1720. The transceiver 1710 provides a means for communicating with various other apparatus over a transmission medium. The transceiver 1710 receives a signal from the one or more antennas 1720, extracts information from the received signal, and provides the extracted information to the processing system 1714, specifically the receiving module 1604. In addition, the transceiver 1710 receives information from the processing system 1714, specifically the communications module 1610, and based on the received information, generates a signal to be applied to the one or more antennas 1720.

The processing system 1714 includes a processor 1704 coupled to a computer-readable medium 1706. The processor 1704 is responsible for general processing, including the execution of software stored on the computer-readable medium 1706. The software, when executed by the processor 1704, causes the processing system 1714 to perform the various functions described supra for any particular apparatus. The computer-readable medium 1706 may also be used for storing data that is manipulated by the processor 1704 when executing software. The processing system further includes at least one of the modules 1604, 1606 and 1608. The modules may be software modules running in the processor 1704, resident/stored in the computer readable medium 1706, one or more hardware modules coupled to the processor 1704, or some combination thereof. The processing system 1714 may be a component of the UE 650 and may include the memory 660 and/or at least one of the TX processor 668, the RX processor 656, and the controller/processor 659.

In one configuration, the UE 1602/1602′ for wireless communication includes means for determining downlink subframes for peer to peer communication within a set of downlink subframes used for both WWAN communication and peer to peer communication. The determined downlink subframes are possibly non-contiguous in the set of downlink subframes. In one configuration the determined downlink subframes are non-contiguous. The UE 1602/1602′ also includes means for communicating with a second UE in a subset of the determined downlink subframes.

The aforementioned means may be one or more of the aforementioned modules of the UE 1602 and/or the processing system 1714 of the UE 1602′ configured to perform the functions recited by the aforementioned means. As described supra, the processing system 1714 may include the TX processor 668, the RX processor 656, and the controller/processor 659. As such, in one configuration, the aforementioned means may be the TX processor 668, the RX processor 656, and the controller/processor 659 configured to perform the functions recited by the aforementioned means.

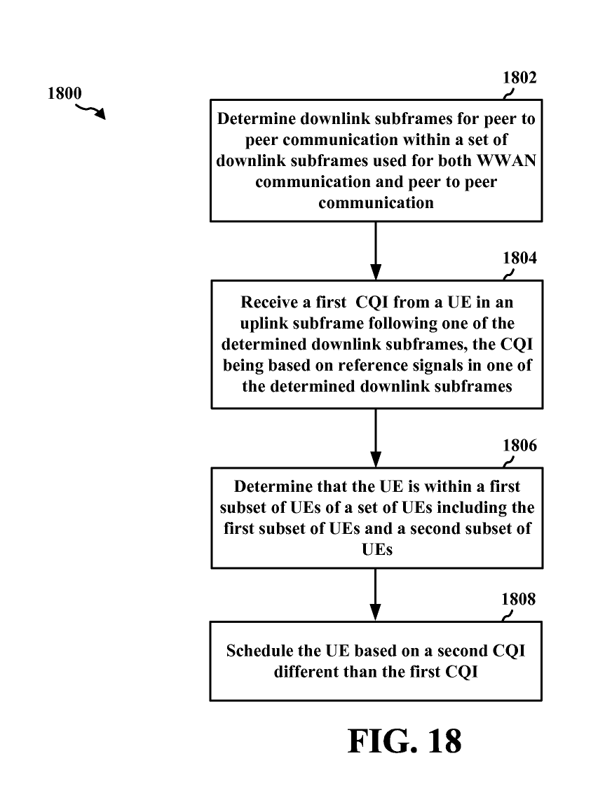

FIG. 18. is a flow chart of a method of wireless communication of a base station, e.g., eNB. This method implements a solution to the legacy UE issues described above, through the base station scheduler. In summary, the base station may ignore or give lower weight to CQI received from legacy UEs during and immediately after subframes reserved for D2D communication. The base station may instead use an older reported value of CQI for the legacy UEs while scheduling them. This is particularly useful in peer discovery where only a small number of subframes are used for D2D communication. As a result the older values are not that out of date. Furthermore, the base station may give lower priority to scheduling of legacy UE during and immediately after subframes reserved for D2D communication. This way UEs are not scheduled with incorrect CQI.

Continuing with FIG. 18, at step 1802, the base station determines downlink subframes for peer to peer communication within a set of downlink subframes used for both WWAN communication and peer to peer communication. Subframes for peer to peer communication may be pre-assigned by the base station or the network.

At step 1804, the base station receives a first CQI from a UE in an uplink subframe following one of the determined downlink subframes for peer to peer communication. The first CQI is based on reference signals in one of the determined downlink subframes for peer to peer communication.

At step 1806, the base station determines that the UE is within a first subset of UEs of a set of UEs including the first subset of UEs and a second subset of UEs. UEs in the first subset may correspond to legacy UEs, while UEs in the second subset may correspond to non-legacy UEs. The base station determines whether a UE is a legacy UE or a non-legacy UE based on information obtained when the UE is initially associated with the base station.

At step 1808, the base station schedules the UE based on a second CQI different than the first CQI, when the UE is a legacy UE. In one configuration, the second CQI is a CQI that was received before the determined downlink subframes that include the reference signals upon which the first CQI are based. In other words, the second CQI is an older reported CQI for the legacy UE and the based station ignores the first CQI in favor of the second CQI for purposes of scheduling the legacy UEs.

In another configuration, the second CQI is derived from the first CQI such that the second CQI is less than the first CQI. In other words, the base station gives a lower weight to the first CQI because it is received from a legacy UE and this lower weight is reflected in the second CQI corresponding to a portion or fraction of the first CQI. In an additional aspect of the method of FIG. 18, the base station gives a lower priority to scheduling the UE upon determining that the UE is within the first subset of UEs, i.e., the UE is a legacy UE.

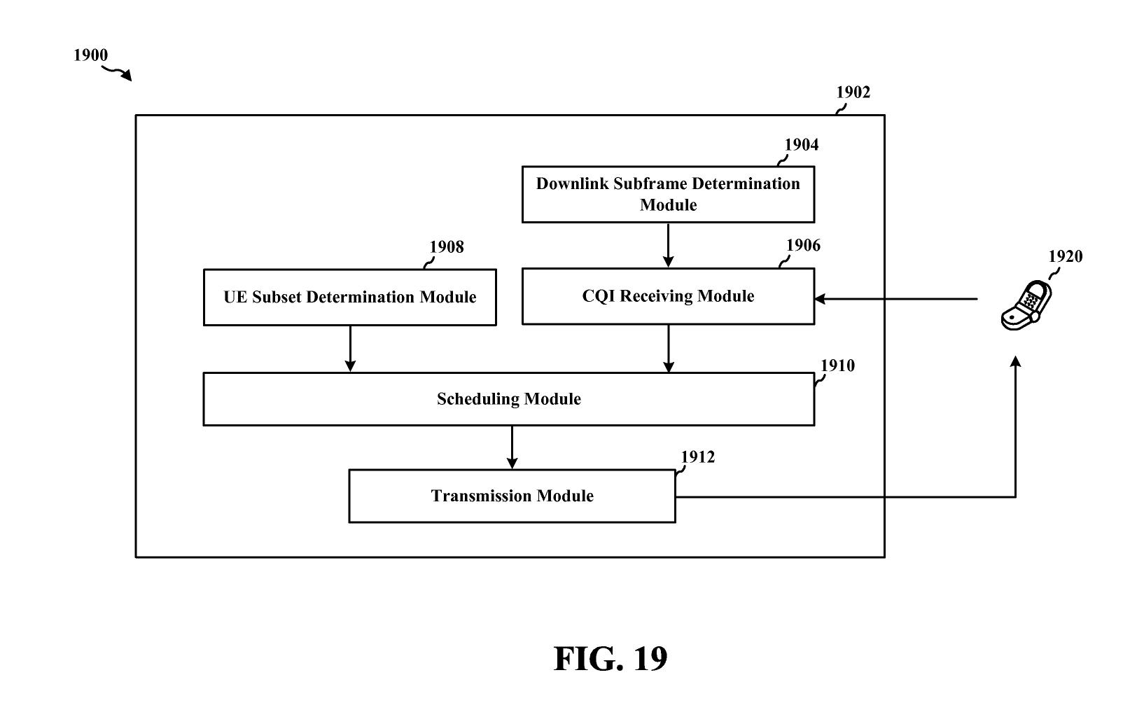

FIG. 19 is a conceptual data flow diagram 1900 illustrating the data flow between different modules/means/components in an exemplary base station 1902. The base station 1902 includes a downlink subframe determination module 1904 that determines downlink subframes for peer to peer communication within a set of downlink subframes used for both WWAN communication and peer to peer communication. The base station 1902 also includes a CQI receiving module 1906 that receives a first CQI from a UE in an uplink subframe following one of the determined downlink subframes. The first CQI is based on reference signals in one of the determined downlink subframes resulting from the operation of the downlink subframe determination module 1904.

The base station 1902 also includes a UE subset determination module 1908 that determines that the UE is within a first subset of UEs of a set of UEs including the first subset of UEs and a second subset of UEs. As mentioned above, UEs in the first subset may correspond to legacy UEs, while UEs in the second subset may correspond to non-legacy UEs. The base station 1902 further includes a scheduling module 1910 that schedules the UE based on a second CQI different than the first CQI when the UE is a legacy UE, and a transmission module 1912 that transmits scheduling information to the UE.

The base station 1902 may include additional modules that perform each of the steps of the algorithm in the aforementioned flow chart of FIG. 18. As such, each step in the aforementioned flow chart of FIG. 18 may be performed by a module and the base station may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

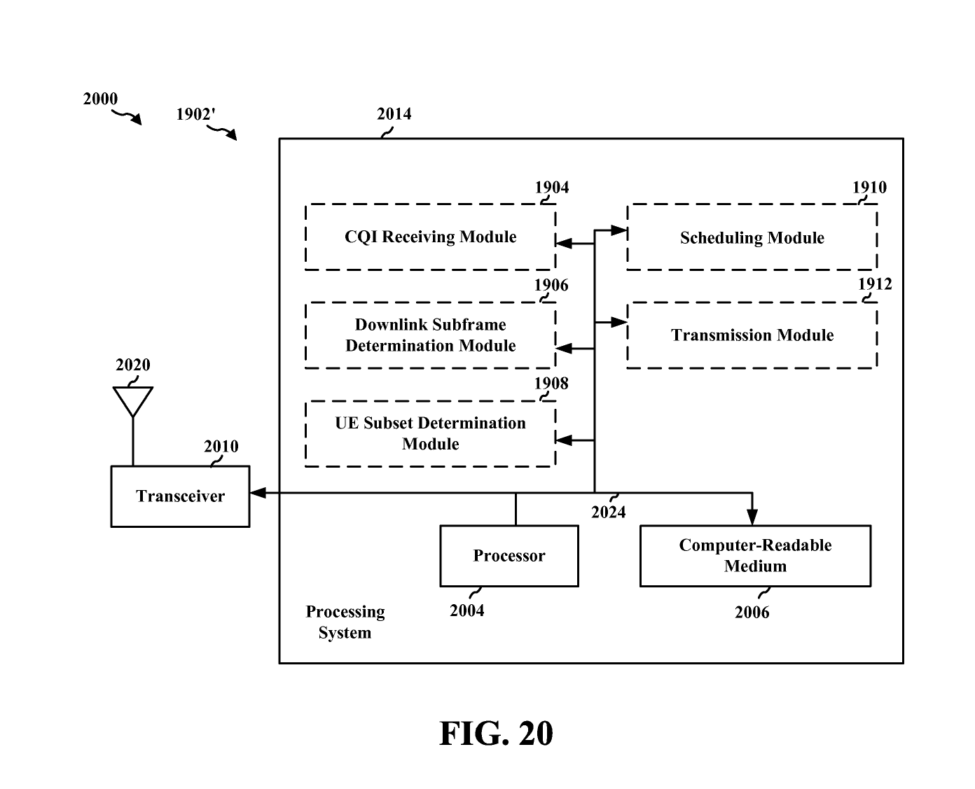

FIG. 20 is a diagram 2000 illustrating an example of a hardware implementation for a base station 1902′ employing a processing system 2014. The processing system 2014 may be implemented with a bus architecture, represented generally by the bus 2024. The bus 2024 may include any number of interconnecting buses and bridges depending on the specific application of the processing system 2014 and the overall design constraints. The bus 2024 links together various circuits including one or more processors and/or hardware modules, represented by the processor 2004, the modules 1904, 1906, 1908, 1910, 1912 and the computer-readable medium 2006. The bus 2024 may also link various other circuits such as timing sources, peripherals, voltage regulators, and power management circuits, which are well known in the art, and therefore, will not be described any further.

The processing system 2014 may be coupled to a transceiver 2010. The transceiver 2010 is coupled to one or more antennas 2020. The transceiver 2010 provides a means for communicating with various other apparatus over a transmission medium. The transceiver 2010 receives a signal from the one or more antennas 2020, extracts information from the received signal, and provides the extracted information to the processing system 2014, specifically the CQI receiving module 1904. In addition, the transceiver 2010 receives information from the processing system 2014, specifically the transmission module 1912, and based on the received information, generates a signal to be applied to the one or more antennas 2020. The processing system 2014 includes a processor 2004 coupled to a computer-readable medium 2006. The processor 2004 is responsible for general processing, including the execution of software stored on the computer-readable medium 2006. The software, when executed by the processor 2004, causes the processing system 2014 to perform the various functions described supra for any particular apparatus. The computer-readable medium 2006 may also be used for storing data that is manipulated by the processor 2004 when executing software. The processing system further includes at least one of the modules 1904, 1906, 1908, 1910 and 1912. The modules may be software modules running in the processor 2004, resident/stored in the computer readable medium 2006, one or more hardware modules coupled to the processor 2004, or some combination thereof. The processing system 2014 may be a component of the eNB 610 and may include the memory 676 and/or at least one of the TX processor 616, the RX processor 670, and the controller/processor 675.

In one configuration, the base station 1902/1902′ for wireless communication includes means for determining downlink subframes for peer to peer communication within a set of downlink subframes used for both WWAN communication and peer to peer communication, and means for receiving a first CQI from a UE in an uplink subframe following one of the determined downlink subframes, wherein the first CQI is based on reference signals in one of the determined downlink subframes. The base station 1902/1902′ also includes means for determining that the UE is within a first subset of UEs of a set of UEs including the first subset of UEs and a second subset of UEs, and means for scheduling the UE based on a second CQI different than the first CQI. The base station 1902/1902′ also includes means for receiving the second CQI before the determined downlink subframes; means for determining the second CQI based on the first CQI, the second CQI being less than the first CQI; and means for determining to give a lower priority to scheduling the UE upon determining that the UE is within the first subset of UEs.

The aforementioned means may be one or more of the aforementioned modules of the apparatus 1902 and/or the processing system 2014 of the apparatus 1902′ configured to perform the functions recited by the aforementioned means. As described supra, the processing system 2014 may include the TX Processor 616, the RX Processor 670, and the controller/processor 675. As such, in one configuration, the aforementioned means may be the TX Processor 616, the RX Processor 670, and the controller/processor 675 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication of a user equipment (UE), comprising:
determining resource elements, within at least one resource block in a downlink subframe, carrying reference signals from a base station;
mapping at least one of data or control information to the at least one resource block;
puncturing the at least one of the data or the control information from the resource elements determined to carry the reference signals; and
transmitting the at least one resource block to a second UE.

2. The method of claim 1, further comprising determining downlink subframes for peer to peer communication within a set of downlink subframes used for both wireless wide area network (WWAN) communication and peer to peer communication, the determined downlink subframes being possibly non-contiguous in the set of downlink subframes, wherein the downlink subframe is within one of the determined downlink subframes.

3. The method of claim 1, wherein the wireless communication is in a time division duplex (TDD) system.

4. A user equipment (UE) for wireless communication, comprising:
means for determining resource elements, within at least one resource block in a downlink subframe, carrying reference signals from a base station;
means for mapping at least one of data or control information to the at least one resource block;
means for puncturing the at least one of the data or the control information from the resource elements determined to carry the reference signals; and
means for transmitting the at least one resource block to a second UE.

5. The UE of claim 4, further comprising means for determining downlink subframes for peer to peer communication within a set of downlink subframes used for both wireless wide area network (WWAN) communication and peer to peer communication, the determined downlink subframes being possibly non-contiguous in the set of downlink subframes, wherein the downlink subframe is within one of the determined downlink subframes.

6. A user equipment (UE) for wireless communication, comprising:
a processing system configured to:
determine resource elements, within at least one resource block in a downlink subframe, carrying reference signals from a base station;
map at least one of data or control information to the at least one resource block;
puncture the at least one of the data or the control information from the resource elements determined to carry the reference signals; and
transmit the at least one resource block to a second UE.

7. The UE of claim 6, the processing system configured to determine downlink subframes for peer to peer communication within a set of downlink subframes used for both wireless wide area network (WWAN) communication and peer to peer communication, the determined downlink subframes being possibly non-contiguous in the set of downlink subframes, wherein the downlink subframe is within one of the determined downlink subframes.

8. A computer program product for a user equipment (UE), comprising:
a computer-readable medium comprising code for:
determining resource elements, within at least one resource block in a downlink subframe, carrying reference signals from a base station;
mapping at least one of data or control information to the at least one resource block;
puncturing the at least one of the data or the control information from the resource elements determined to carry the reference signals; and
transmitting the at least one resource block to a second UE.

9. The product of claim 8, further comprising code for determining downlink subframes for peer to peer communication within a set of downlink subframes used for both wireless wide area network (WWAN) communication and peer to peer communication, the determined downlink subframes being possibly non-contiguous in the set of downlink subframes, wherein the downlink subframe is within one of the determined downlink subframes.

10. A method of wireless communication of a user equipment (UE), comprising:
determining resource elements, within at least one resource block in a downlink subframe, that normally carry reference signals from a base station; and
transmitting a pilot signal on the determined resource elements.

11. The method of claim 10, further comprising transmitting at least one of data or control information on remaining resource elements within the at least one resource block.

12. The method of claim 10, wherein the pilot signal is a sequence y₁, y₂, . . . , yₖ determined such that Σⱼ₌₁^{k}conjugate(xⱼ)yⱼ is zero or low, where x₁, x₂, . . . , xₖ is a sequence corresponding to a pilot signal normally transmitted by the base station on the resource elements.

13. The method of claim 10, further comprising determining downlink subframes for peer to peer communication within a set of downlink subframes used for both wireless wide area network (WWAN) communication and peer to peer communication, the determined downlink subframes being possibly non-contiguous in the set of downlink subframes, wherein the downlink subframe is within one of the determined downlink subframes.

14. The method of claim 10, wherein the wireless communication is in a time division duplex (TDD) system.

15. A user equipment (UE) for wireless communication, comprising:
means for determining resource elements, within at least one resource block in a downlink subframe, that normally carry reference signals from a base station; and
means transmitting a pilot signal on the determined resource elements.

16. The UE of claim 15, further comprising means for transmitting at least one of data or control information on remaining resource elements within the at least one resource block.

17. The UE of claim 15, wherein the pilot signal is a sequence y₁, y₂, . . . , yₖ determined such that Σⱼ₌₁^{k}conjugate(xⱼ)yⱼ is zero or low, where x₁, x₂, . . . , xₖ is a sequence corresponding to a pilot signal normally transmitted by the base station on the resource elements.

18. The UE of claim 15, further comprising means for determining downlink subframes for peer to peer communication within a set of downlink subframes used for both wireless wide area network (WWAN) communication and peer to peer communication, the determined downlink subframes being possibly non-contiguous in the set of downlink subframes, wherein the downlink subframe is within one of the determined downlink subframes.

19. A user equipment (UE) for wireless communication, comprising:
a processing system configured to:
determine resource elements, within at least one resource block in a downlink subframe, that normally carry reference signals from a base station; and
transmit a pilot signal on the determined resource elements.

20. The UE of claim 19, wherein the processing system is further configured to transmit at least one of data or control information on remaining resource elements within the at least one resource block.

21. The UE of claim 19, wherein the pilot signal is a sequence y₁, y₂, . . . , yₖ determined such that Σⱼ₌₁^{k}conjugate(xⱼ)yⱼ is zero or low, where x₁, x₂, . . . , xₖ is a sequence corresponding to a pilot signal normally transmitted by the base station on the resource elements.

22. The UE of claim 19, wherein the processing system is further configured to determine downlink subframes for peer to peer communication within a set of downlink subframes used for both wireless wide area network (WWAN) communication and peer to peer communication, the determined downlink subframes being possibly non-contiguous in the set of downlink subframes, wherein the downlink subframe is within one of the determined downlink subframes.

23. A computer program product for a user equipment (UE), comprising:
a computer-readable medium comprising code for:
determining resource elements, within at least one resource block in a downlink subframe, that normally carry reference signals from a base station; and
transmitting a pilot signal on the determined resource elements.

24. The product of claim 23, further comprising code for transmitting at least one of data or control information on remaining resource elements within the at least one resource block.

25. The UE of claim 23, wherein the pilot signal is a sequence y₁, y₂, . . . , yₖ determined such that Σⱼ₌₁^{k}conjugate(xⱼ)yⱼ is zero or low, where x₁, x₂, . . . , xₖ is a sequence corresponding to a pilot signal normally transmitted by the base station on the resource elements.

26. The UE of claim 23, further comprising code for determining downlink subframes for peer to peer communication within a set of downlink subframes used for both wireless wide area network (WWAN) communication and peer to peer communication, the determined downlink subframes being possibly non-contiguous in the set of downlink subframes, wherein the downlink subframe is within one of the determined downlink subframes.

27. A method of wireless communication of a user equipment (UE), comprising:
determining downlink subframes for peer to peer communication within a set of downlink subframes used for both wireless wide area network (WWAN) communication and peer to peer communication, the determined downlink subframes being possibly non-contiguous in the set of downlink subframes; and
communicating with a second UE in a subset of the determined downlink subframes.

28. The method of claim 27, wherein the wireless communication is in a time division duplex (TDD) system.

29. A user equipment (UE) for wireless communication, comprising:
means for determining downlink subframes for peer to peer communication within a set of downlink subframes used for both wireless wide area network (WWAN) communication and peer to peer communication, the determined downlink subframes being possibly non-contiguous in the set of downlink subframes; and
means for communicating with a second UE in a subset of the determined downlink subframes.

30. A user equipment (UE) for wireless communication, comprising:
a processing system configured to:
determine downlink subframes for peer to peer communication within a set of downlink subframes used for both wireless wide area network (WWAN) communication and peer to peer communication, the determined downlink subframes being possibly non-contiguous in the set of downlink subframes; and
communicate with a second UE in a subset of the determined downlink subframes.

31. A computer program product for a user equipment (UE), comprising:
a computer-readable medium comprising code for:
determining downlink subframes for peer to peer communication within a set of downlink subframes used for both wireless wide area network (WWAN) communication and peer to peer communication, the determined downlink subframes being possibly non-contiguous in the set of downlink subframes; and
communicating with a second UE in a subset of the determined downlink subframes.

32. A method of wireless communication of a base station, comprising:
determining downlink subframes for peer to peer communication within a set of downlink subframes used for both wireless wide area network (WWAN) communication and peer to peer communication;
receiving a first channel quality indicator (CQI) from a user equipment (UE) in an uplink subframe following one of the determined downlink subframes, the CQI being based on reference signals in one of the determined downlink subframes;
determining that the UE is within a first subset of UEs of a set of UEs including the first subset of UEs and a second subset of UEs; and
scheduling the UE based on a second CQI different than the first CQI.

33. The method of claim 32, further comprising receiving the second CQI before said one of the determined downlink subframes.

34. The method of claim 32, further comprising determining the second CQI based on the first CQI, the second CQI being less than the first CQI.

35. The method of claim 32, further comprising determining to give a lower priority to scheduling the UE upon determining that the UE is within the first subset of UEs.

36. The method of claim 32, wherein the determined downlink subframes are possibly non-contiguous in the set of downlink subframes.

37. The method of claim 32, wherein the wireless communication is in a time division duplex (TDD) system.

38. A base station for wireless communication, comprising:
means for determining downlink subframes for peer to peer communication within a set of downlink subframes used for both wireless wide area network (WWAN) communication and peer to peer communication;
means for receiving a first channel quality indicator (CQI) from a user equipment (UE) in an uplink subframe following one of the determined downlink subframes, the CQI being based on reference signals in one of the determined downlink subframes;
means for determining that the UE is within a first subset of UEs of a set of UEs including the first subset of UEs and a second subset of UEs; and
means for scheduling the UE based on a second CQI different than the first CQI.

39. The base station of claim 38, further comprising means for receiving the second CQI before said one of the determined downlink subframes.

40. The base station of claim 38, further comprising means for determining the second CQI based on the first CQI, the second CQI being less than the first CQI.

41. The base station of claim 38, further comprising means for determining to give a lower priority to scheduling the UE upon determining that the UE is within the first subset of UEs.

42. The base station of claim 38, wherein the determined downlink subframes are possibly non-contiguous in the set of downlink subframes.

43. A base station for wireless communication, comprising:
a processing system configured to:
determine downlink subframes for peer to peer communication within a set of downlink subframes used for both wireless wide area network (WWAN) communication and peer to peer communication;
receive a first channel quality indicator (CQI) from a user equipment (UE) in an uplink subframe following one of the determined downlink subframes, the CQI being based on reference signals in one of the determined downlink subframes;
determine that the UE is within a first subset of UEs of a set of UEs including the first subset of UEs and a second subset of UEs; and
schedule the UE based on a second CQI different than the first CQI.

44. The base station of claim 43, wherein the processing system is further configured to receive the second CQI before said one of the determined downlink subframes.

45. The base station of claim 43, wherein the processing system is further configured to determine the second CQI based on the first CQI, the second CQI being less than the first CQI.

46. The base station of claim 43, wherein the processing system is further configured to determine to give a lower priority to scheduling the UE upon determining that the UE is within the first subset of UEs.

47. The base station of claim 43, wherein the determined downlink subframes are possibly non-contiguous in the set of downlink subframes.

48. The base station of claim 43, wherein the wireless communication is in a time division duplex (TDD) system.

49. A computer program product for a base station, comprising:
a computer-readable medium comprising code for:
determining downlink subframes for peer to peer communication within a set of downlink subframes used for both wireless wide area network (WWAN) communication and peer to peer communication;
receiving a first channel quality indicator (CQI) from a user equipment (UE) in an uplink subframe following one of the determined downlink subframes, the CQI being based on reference signals in one of the determined downlink subframes;
determining that the UE is within a first subset of UEs of a set of UEs including the first subset of UEs and a second subset of UEs; and
scheduling the UE based on a second CQI different than the first CQI.

50. The computer program product of claim 49, further comprising code for receiving the second CQI before said one of the determined downlink subframes.

51. The computer program product of claim 49, further comprising code for determining the second CQI based on the first CQI, the second CQI being less than the first CQI.

52. The computer program product of claim 49, further comprising code for determining to give a lower priority to scheduling the UE upon determining that the UE is within the first subset of UEs.

53. The computer program product of claim 49, wherein the determined downlink subframes are possibly non-contiguous in the set of downlink subframes.
